(19) United States
(12) Patent Application Publication
(10) Pub. No.: US 2002/0064231 A1
(43) Pub. Date: May 30, 2002

(54) Video encoding method using a wavelet decomposition

(76) Inventors: Boris Felts, Marseille (FR); Beatrice Pesquet-Popescu, Fontenay-Sous-Bois (FR)

Correspondence Address: U.S. Philips Corporation, 580 White Plains Road, Tarrytown, NY, 10591, US

(21) Appl. No.: 09/912,130

(22) Filed: Jul. 24, 2001

(30) Foreign Application Priority Data
Jul. 25, 2000 (EP) 00402124.2

(51) Int. Cl. H04N 7/12

(52) U.S. Cl. 375/240.21

(57) ABSTRACT

In order to compress a video sequence under the constraint of scability, the known 2D or 3D SPIHT, based on the prediction of the absence of significant information across scales of a wavelet decomposition, compares a set of pixels, corresponding to the same image area at different resolutions, to a value called level of significance. In both cases, the transform coefficients are ordered by means of magnitude tests involving the pixels represented by three ordered lists called list of insignificant sets (LIS), list of insignificant pixels (LIP) and list of significant pixels (LSP). In the original video sequence, the value of a pixel depends on those of the pixels surrounding it. The estimation of the probability of a symbol given the d previous bits becomes a difficult task when the number of conditioning events increases. The object of the invention is to propose an efficient video encoding method, reflecting the changes in the behavior of the information sources that contribute to the bitstream: for the estimation of the probabilities of occurrence of the symbols 0 and 1 in the lists at each level of significance, four models represented by four context-trees, are considered, these models corresponding to the LIS, LIP, LSP and a distinction is made between the models for the coefficients of luminance and those for the chrominance.

The present invention relates to an encoding method for the compression of a video sequence divided in groups of frames decomposed by means of a three-dimensional (3D) wavelet transform leading to a given number of successive resolution levels, said method being based on the hierarchical subband encoding process called “set partitioning in hierarchical trees” (SPIHT) and leading from the original set of picture elements (pixels) of the video sequence to wavelet transform coefficients encoded with a binary format, said coefficients being organized in trees and ordered into partitioning subsets—corresponding to respective levels of significance—by means of magnitude tests involving the pixels represented by three ordered lists called list of insignificant sets (LIS), list of insignificant pixels (LIP) and list of significant pixels (LSP), said tests being carried out in order to divide said original set of pixels into said partitioning subsets according to a division process that continues until each significant coefficient is encoded within said binary representation, and sign bits being also put in the output bitstream to be transmitted.

Classical video compression schemes may be considered as comprising four main modules motion estimation and compensation, transformation in coefficients (for instance, discrete cosine transform or wavelet decomposition), quantification and encoding of the coefficients, and entropy coding. When a video encoder has moreover to be scalable, this means that it must be able to encode images from low to high bit rates, increasing the quality of the video with the rate. By naturally providing a hierarchical representation of images, a transform by means of a wavelet decomposition appears to be more adapted to scalable schemes than the conventional discrete cosine transform (DCT).

A wavelet decomposition allows an original input signal to be described by a set of subband signals. Each subband represents in fact the original signal at a given resolution level and in a particular frequency range. This decomposition into uncorrelated subbands is generally implemented by means of a set of monodimensional filter banks applied first to the lines of the current image and then to the columns of the resulting filtered image. An example of such an implementation is described in “Displacements in wavelet decomposition of images”, by S. S. Goh, Signal Processing, vol. 44, n° 1, June 1995, pp.27-38. Practically two filters—a low-pass one and a high-pass one—are used to separate low and high frequencies of the image. This operation is first carried out on the lines and followed by a sub-sampling operation, by a factor of 2, and then carried out on the columns of the sub-sampled image, the resulting image being also down-sampled by 2. Four images, four times smaller than the original one, are thus obtained: a low-frequency sub-image (or “smoothed image”), which includes the major part of the initial content of the concerned original image and therefore represents an approximation of said image, and three high-frequency sub-images, which contain only horizontal, vertical and diagonal details of said original image. This decomposition process continues until it is clear that there is no more useful information to be derived from the last smoothed image.

A technique rather computationally simple for image compression, using a two-dimensional (2D) wavelet decomposition, is described in “A new, fast, and efficient image codec based on set partitioning in hierarchical trees (=SPIHT)”, by A. Said and W. A. Pearlman, IEEE Transactions on Circuits and Systems for Video Technology, vol.6, n° 3, June 1996, pp.243-250. As explained in said document, the original image is supposed to be defined by a set of pixel values p(x,y), where x and y are the pixel coordinates, and to be coded by a hierarchical subband transformation, represented by the following formula (1):

c(x,y)=Ω(p(x,y)) (1)

where Ω represents the transformation and each element c(x,y) is called “transform coefficient for the pixel coordinates (x,y)”.

The major objective is then to select the most important information to be transmitted first, which leads to order these transform coefficients according to their magnitude (coefficients with larger magnitude have a larger content of information and should be transmitted first, or at least their most significant bits). If the ordering information is explicitly transmitted to the decoder, images with a rather good quality can be recovered as soon as a relatively small fraction of the pixel coordinates are transmitted. If the ordering information is not explicitly transmitted, it is then supposed that the execution path of the coding algorithm is defined by the results of comparisons on its branching points, and that the decoder, having the same sorting algorithm, can duplicate this execution path of the encoder if it receives the results of the magnitude comparisons. The ordering information can then be recovered from the execution path.

One important fact in said sorting algorithm is that it is not necessary to sort all coefficients, but only the coefficients such that 2ⁿ≦|c_{x,y}|<2ⁿ⁺¹, with n decremented in each pass. Given n, if |c_{x,y}|≧2ⁿ (2ⁿ=being called the level of significance), it is said that a coefficient is significant; otherwise it is called insignificant. The sorting algorithm divides the set of pixels into partitioning subsets Tₘ and performs the magnitude test (2):

$${max}_{( x , y ) ∈ {T}_{m}} \{ \vert {c}_{x , y} \vert \} \geq {2}^{n} ? \qquad ( 2 )$$

If the decoder receives a “no” (the whole concerned subset is insignificant), then it knows that all coefficients in this subset Tₘ are insignificant. If the answer is “yes” (the subset is significant), then a predetermined rule shared by the encoder and the decoder is used to partition Tₘ into new subsets T_{m,1}, the significance test being further applied to these new subsets. This set division process continues until the magnitude test is done to all single coordinate significant subsets in order to identify each significant coefficient and to allow to encode it with a binary format.

To reduce the number of transmitted magnitude comparisons (i.e. of message bits), one may define a set partitioning rule that uses an expected ordering in the hierarchy defined by the subband pyramid. The objective is to create new partitions such that subsets expected to be insignificant contain a large number of elements, and subsets expected to be significant contain only one element. To make clear the relationship between magnitude comparisons and message bits, the following function is used:

$${S}_{n} ( T ) = \{ \begin{matrix}1 , & { max}_{( x , y ) ∈ T} \{ \vert {c}_{x , y} \vert \} \geq {2}^{n} , \\ 0 , & otherwise ,\end{matrix} \qquad ( 3 )$$

to indicate the significance of a subset of coordinates T.

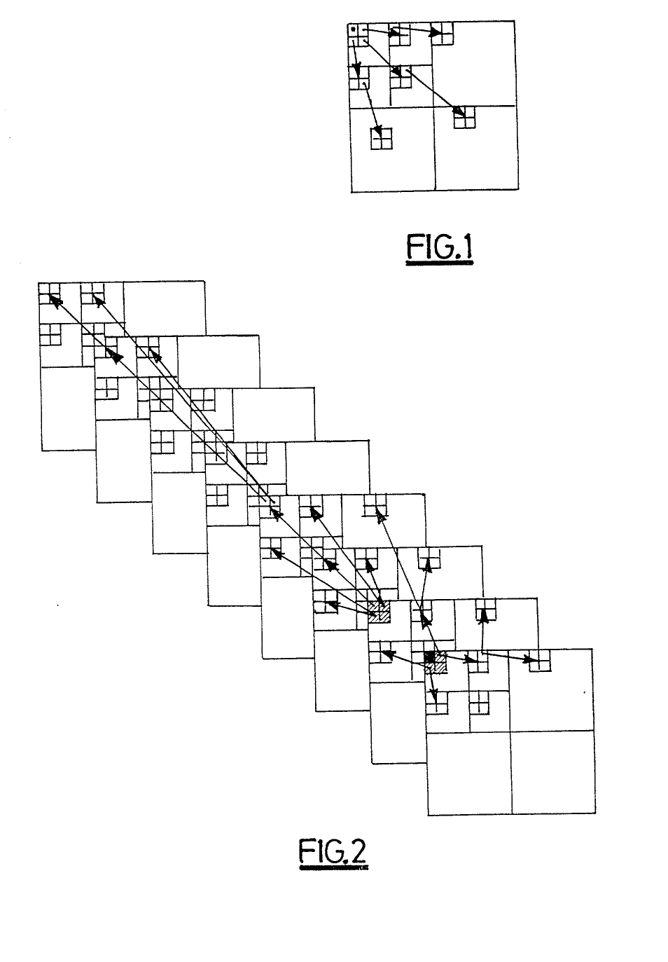

Furthermore, it has been observed that there is a spatial self-similarity between subbands, and the coefficients are expected to be better magnitude-ordered if one moves downward in the pyramid following the same spatial orientation. For instance, if low-activity areas are expected to be identified in the highest levels of the pyramid, then they are replicated in the lower levels at the same spatial locations. A tree structure, called spatial orientation tree, naturally defines the spatial relationship on the hierarchical pyramid of the wavelet decomposition. FIG. 1 shows how the spatial orientation tree is defined in a pyramid constructed with recursive four-subband splitting. Each node of the tree corresponds to the pixels of the same spatial orientation in the way that each node has either no offspring (the leaves) or four offspring, which always form a group of 2×2 adjacent pixels. In FIG. 1, the arrows are oriented from the parent node to its offspring. The pixels in the highest level of the pyramid are the tree roots and are also grouped in 2×2 adjacent pixels. However, their offspring branching rule is different, and in each group, one of them (indicated by the star in FIG. 1) has no descendant.

The following sets of coordinates are used to present this coding method, (x,y) representing the location of the coefficient):

0(x,y): set of coordinates of all offspring of node (x,y);

D(x,y): set of coordinates of all descendants of the node (x,y);

H: set of coordinates of all spatial orientation tree roots (nodes in the highest pyramid level);

L(x,y)=D(x,y)−0(x,y).

As it has been observed that the order in which the subsets are tested for significance is important, in a practical implementation the significance information is stored in three ordered lists, called list of insignificant sets (LIS), list of insignificant pixels (LIP), and list of significant pixels (LSP). In all these lists, each entry is identified by coordinates (i,j), which in the LIP and LSP represent individual pixels, and in the LIS represent either the set D(i,j) or L(i,j) (to differentiate between them, a LIS entry may be said of type A if it represents D(i,j), and of type B if it represents L(i,j)). The SPIHT algorithm is in fact based on the manipulation of the three lists LIS, LIP and LSP.

The 2D SPIHT algorithm is based on a key concept: the prediction of the absence of significant information across scales of the wavelet decomposition by exploiting self-similarity inherent in natural images. This means that if a coefficient is insignificant at the lowest scale of the wavelet decomposition, the coefficients corresponding to the same area at the other scales have great chances to be insignificant too. Basically, the SPIHT algorithm consists in comparing a set of pixels corresponding to the same image area at different resolutions to the value previously called “level of significance”.

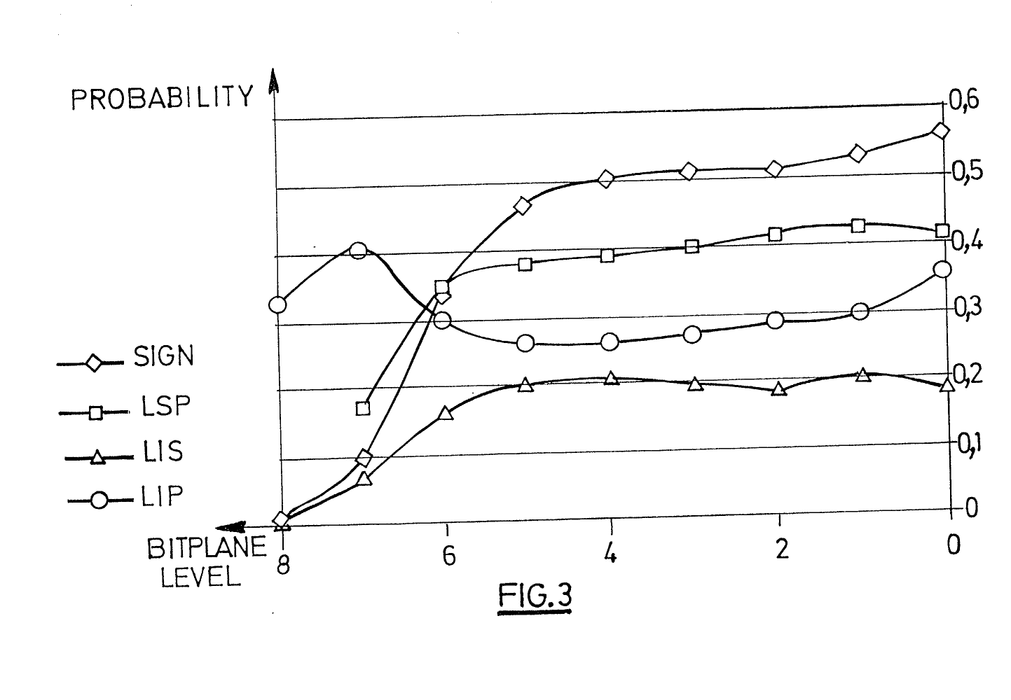

The 3D SPIHT algorithm does not differ greatly from the 2D one. A 3D-wavelet decomposition is performed on a group of frames (GOF). Following the temporal direction, a motion compensation and a temporal filtering are realized. Instead of spatial sets (2D), one has 3D spatio-temporal sets, and trees of coefficients having the same spatio-temporal orientation and being related by parent-offspring relationships can be also defined. These links are illustrated in the 3D case in FIG. 2. The roots of the trees are formed with the pixels of the approximation subband at the lowest resolution (“root” subband). In the 3D SPIHT algorithm, in all the subbands but the leaves, each pixel has 8 offspring pixels, and mutually, each pixel has only one parent. There is one exception at this rule: in the root case, one pixel out of 8 has no offspring.

As in the 2D case, a spatio-temporal orientation tree naturally defines the spatio-temporal relationship on the hierarchical wavelet decomposition, and the following sets of coordinates are used:

0(x,y,z chroma) set of coordinates of all offspring of node (x,y,z chroma);

D(x,y,z chroma): set of coordinates of all descendants of the node (x,y,z chroma);

H(x,y,z chroma): set of coordinates of all spatio-temporal orientation tree roots (nodes in the highest pyramid level);

L(x,y,z, chroma)=D(x,y,z, chroma)−0(x,y,z, chroma);

where (x,y,z) represents the location of the coefficient and “chroma” stands for Y, U or V. Three ordered lists are also defined: LIS (list of insignificant sets), LIP (list of insignificant pixels), LSP (list of significant pixels). In all these lists, each entry is identified by a coordinate (x,y,z, chroma), which in the LIP and LSP represents individual pixels, and in the LIS represents one of D(x,y,z, chroma) or L(x,y,z, chroma) sets. To differentiate between them, the LIS entry is of type A if it represents D(x,y,z, chroma), and of type B if it represents L(x,y,z, chroma). As previously in the 2D case, the algorithm 3D SPIHT is based on the manipulation of these three lists LIS, LIP and LSP.

Unfortunately, the SPIHT algorithm, which exploits the redundancy between the subbands, destroys the dependencies between neighboring pixels inside each subband. The manipulation of the lists LIS, LIP, LSP, conducted by a set of logical conditions, makes indeed the order of pixel scanning hardly predictable. The pixels belonging to the same 3D offspring tree but from different spatio-temporal subbands are encoded and put one after the other in the lists, which has for effect to mix the pixels of foreign subbands. Thus, the geographic interdependencies between pixels of the same subband are lost. Moreover, since the spatio-temporal subbands result from temporal or spatial filtering, the frames are filtered along privileged axes that give the orientation of the details. This orientation dependency is lost when the SPIHT algorithm is applied, because the scanning does not respect the geographic order. To improve the scanning order and reestablish the relations of neighborhood between pixels of the same subband, a specific initial organization of the LIS and a particular order of reading the offspring have been proposed.

This solution, that allows to re-establish partially a geographic scan of the coefficients and is described in a European patent application previously filed on Apr. 4, 2000, by the Applicant under the official filing number 00400932.0 (PHFR000032), relates to an encoding method for the compression of a video sequence divided in groups of frames decomposed by means of a three-dimensional wavelet transform leading to a given number of successive resolution levels, said method using the SPIHT process and leading from the original set of picture elements of the video sequence to wavelet transform coefficients encoded with a binary format, said coefficients being organized into spatio-temporal orientation trees rooted in the lowest frequency, or spatio-temporal approximation, subband and completed by an offspring in the higher frequency subbands, the coefficients of said trees being further ordered into partitioning sets corresponding to respective levels of significance and defined by means of magnitude tests leading to a classification of the significance information in three ordered lists called list of insignificant sets (LIS), list of insignificant pixels (LIP) and list of significant pixels (LSP), said tests being carried out in order to divide said original set of picture elements into said partitioning sets according to a division process that continues until each significant coefficient is encoded within said binary representation. More precisely, the method described in said document is characterized in that it comprises the following steps:

(A) the spatio-temporal approximation subband that results from the 3D wavelet transform contains the spatial approximation subbands of the two frames in the temporal approximation subband, indexed by z=0 and z=1, and, each pixel having coordinates (x,y,z) varying for x and y from 0 to size_x and from 0 to size_y respectively, said list LIS is then initialized with the coefficients of said spatio-temporal approximation subband, excepting the coefficient having the coordinates of the form z=0 (mod 2), x=0 (mod 2) and y=0 (mod 2), the initialization order of the LIS being the following:

(a) put in the list all the pixels that verify x=0 (mod. 2) and y=0 (mod. 2) and z=1, for the luminance component Y and then for the chrominance components U and V;

(b) put in the list all the pixels that verify x=1 (mod. 2) and y=0 (mod. 2) and z=0, for Y and then for U and V;

(c) put in the list all the pixels that verify x=1 (mod. 2) and y=1 (mod. 2) and z=0, for Y and then for U and V;

(d) put in the list all the pixels that verify x=0 (mod. 2) and y=1 (mod. 2) and z=0, for Y and then for U and V;

(B) the spatio-temporal orientation trees defining the spatio-temporal relationship in the hierarchical subband pyramid of the wavelet decomposition are explored from the lowest resolution level to the highest one, while keeping neighboring pixels together and taking account of the orientation of the details, said exploration of the offspring coefficients being implemented thanks to a scanning order of said coefficients in the case of horizontal and diagonal detail subbands, specifically for a group of four offspring and the passage of said group to the next one in the horizontal direction, for a group of four offspring and for the lowest and finer resolution levels.

For the entropy coding module, the arithmetic encoding is a widespread technique which is more effective in video compression than the Huffmann encoding owing to the following reasons: the obtained codelength is very close to the optimal length, the method particularly suits adaptive models (the statistics of the source are estimated on the fly), and it can be split into two independent modules (the modeling one and the coding one). The following description relates mainly to modeling, which involves the determination of certain source-string events and their context (the context is intended to capture the redundancies of the entire set of source strings under consideration), and the way to estimate their related statistics.

In the original video sequence, the value of a pixel indeed depends on those of the pixels surrounding it. After the wavelet decomposition, the same property of “geographic” interdependency holds in each spatio-temporal subband. If the coefficients are sent in an order that preserves these dependencies, it is possible to take advantage of the “geographic” information in the framework of universal coding of bounded memory tree sources, as described for instance in the document “A universal finite memory source”, by M. J. Weinberger and al., IEEE Transactions on Information Theory, vol. 41, n° 3, May 1995, pp. 643-652. A finite memory tree source has the property that the next symbol probabilities depend on the actual values of a finite number of the most recent symbols (the context). Binary sequential universal source coding procedures for finite memory tree sources often make use of context tree which contains for each string (context) the number of occurrences of zeros and ones given the considered context. This tree allows to estimate the probability of a symbol, given the d previous bits:

\hat{P}(Xₙ|xₙ₋₁ . . . x_{n-d}), where xₙ is the value of the examined bit and xₙ₋₁ . . . x_{n-d} represents the context, i.e. the previous sequence of d bits. This estimation turns out to be a difficult task when the number of conditioning events increases because of the context dilution problem or the model cost. One way to solve this problem by reducing the model redundancy while keeping a reasonable complexity is the context-tree weighting method, or CTW, detailed for example in “The context-tree weighting method: basic properties”, by F. M. J. Willems and al., IEEE Transactions on Information Theory, vol. 41, n° 3, May 1995, pp. 653-664.

The principle of this method which reduces the length of the final code is to estimate weighted probabilities using the most efficient context for the examined bit (sometimes it can be better to use shorter contexts to encode a bit: if the last bits of the context have no influence on the current bit, they might not be taken into account). If one denotes by X₁^{t}=x₁ . . . xₜ the source sequence of bits and if it is supposed that both the encoder and the decoder have access to the previous d symbols x_{1-d}⁰, the CTW method associates to each node s of the context tree, representing a string of length k of binary symbols, a weighted probability P_{w}^{s} estimated recursively by weighting an intrinsic probability Pₑ^{s} of the node with those of its two sons by starting from the leaves of the tree:

$${P}_{w}^{s} = \{ \begin{matrix} {P}_{e}^{s} & for the leaves \\ \frac{1}{2} {P}_{e}^{s} + \frac{1}{2} {P}_{w}^{Os} {P}_{w}^{1 s} & for 0 \leq k < d ,\end{matrix}$$

It is verified that such a weighted model minimizes the model redundancy. The conditional probabilities of the symbols 0 and 1 given the previous sequence x₁^{t-1} and x_{1-d}⁰ are estimated using the following relations:

$${P}_{e}^{s} ( {X}_{t} = 0 \vert {x}_{1}^{t - 1} , {x}_{1 - d}^{0} ) = \frac{{n}_{o} + 1 / 2}{{n}_{o} + {n}_{1} + 1}$$

$${P}_{e}^{s} ( {X}_{t} = 1 \vert {x}_{1}^{t - 1} , {x}_{1 - d}^{0} ) = \frac{{n}_{1} + 1 / 2}{{n}_{o} + {n}_{1} + 1}$$

where nₒ, resp.n₁ are conditional counts of 0 and 1 in the sequence x₁^{t-1}. This CTW method is used to estimate the probabilities needed by the arithmetic encoding module.

It is an object of the invention to propose a more efficient video encoding method reflecting the changes in the behavior of the information sources that contribute to the bitstream.

To this end, the invention relates to an encoding method such as defined in the introductory part of the description and which is moreover characterized in that, for the estimation of the probabilities of occurrence of the symbols 0 and 1 in said lists at each level of significance, four models, represented by four context-trees, are considered, these models corresponding to the LIS, LIP, LSP and sign, and a further distinction is made between the models for the coefficient of luminance and those for the chrominance, without differentiating the U and V coefficients.

The invention will now be described in a more detailed manner, with reference to the accompanying drawings in which:

FIG. 1 shows examples of parent-offspring dependencies in the spatial orientation tree in the two-dimensional case;

FIG. 2 shows similarly examples of parent-offspring dependencies in the spatio-temporal orientation tree, in the three-dimensional case;

FIG. 3 shows the probabilities of occurrence of the symbol 1 according to the bitplane level, for each type of model with estimations performed for instance on 30 video sequences.

During the successive passes of the implementation of the SPIHT algorithm, coordinates of pixels are moved from one of the three lists LIS, LIP, LSP to the other, and bits of significance are output. The sign bits are also put in the bitstream before transmitting the bits of a coefficient. From a statistical point of view, the behaviors of the three lists and that of the sign bitmap are quite different. For example, the list LIP represents the set of insignificant pixels; it is likely that, if a pixel is surrounded by insignificant pixels, it is probably insignificant too. On the contrary, it seems difficult, with respect to the list LSP, to assume that, if the refinement bits of the neighbors of a pixel are ones (resp. zeros) at a given level of significance, the refinement bit of the examined pixel is also one (resp. zero). An examination of the estimated probabilities of occurrence of the symbols 0 and 1 in these lists at each level of significance shows that these hypotheses seem to be confirmed. This observation leads to consider an additional independent model, provided for the sign. One has now four different models, represented by four context-trees for the estimation of probabilities and corresponding to the LIS, LIP, LSP and sign:

LIS→LIS_TYPE

LIP→LIP_TYPE

LSP→LSP_TYPE

SIGN→SIGN_TYPE

Another distinction has to be made between the models for the coefficients of luminance and those for the coefficients of chrominance, but however without differentiating the U and V planes among the chrominance coefficients: the same context tree is used to estimate the probabilities for the coefficients belonging to these two color-planes, since they share common statistical properties. Moreover, there would not be enough values to estimate properly the probabilities if distinct models were considered (experiments made with disjoint models for U and V give lower compression rates). Finally, one has 8 context trees (only 4 in black and white video).

When considering the probabilities of occurrence of symbols in different bitplanes, illustrated in FIG. 3, differences are observed between them, and preliminary experiments have shown that the re-initialization of models at each bitplane gives better compression results, which justifies to consider one model per bitplane. However, taking the same model for several bitplanes sharing common characteristics could reduce the computational complexity and improve the performance of the encoding method.

Having distinguished 2×4 models (represented by context trees and used to estimate conditional probabilities), it is necessary to do at least the same thing for the contexts (which are simple sequences of d bits preceding the current one and the most recently read). However, the contexts for U and V coefficients are this time distinguished. Indeed, the basic hypothesis that the U-images and V-images have the same statistical behavior (and so, the same context tree, which differs from the one of the Y-images) had been made, but each context must contain bits from only one color-plane. The use of the same context for U and V coefficients would then have as effect to mix two different images (the same sequence would contain mixed bits, belonging to a U-image and to a V-image), which can be avoided. The same distinction for the contexts can be made for the frames of each temporal subband. It can be assumed that they obey to the same statistical model (this hypothesis is quite strong, but a supplementary distinction between models for each temporal subband would multiply the previous set of context trees by the number of temporal subbands, leading to a huge memory place requirement).

A set of contexts has been therefore distinguished for the Y, U, V coefficients and for every frame in the spatio-temporal decomposition. For the implementation, these contexts, formed of d bits, are gathered in a structure depending on:

the type of symbols coming from the LIS, LIP, LSP, or from the sign bitmap);

the color plane (Y, or U, or V);

the frame in the temporal sub-band.

A simple representation of all these contexts is a three-dimensional structure CONTEXT filled with the sequences of d last bits examined in each case:

CONTEXT [TYPE] [chroma] [n° frame] where TYPE is LIP_TYPE, LIS_TYPE, LSP_TYPE, or SIGN_TYPE, and chroma stands for Y, U, or V.

In order to reflect the changes in the statistical models, at the end of each pass in the SPIHT algorithm (before the decreasing of the level of significance, and together with the bitplane change), the contexts and the context trees are re-initialized, which simply consists of resetting to zero the probability counts for each context tree and all the entries of the array of context. This step, necessary in order to reflect said changes, has been confirmed by experiments: better rates have been obtained when a re-initialization is performed at the end of each pass.

1. An encoding method for the compression of a video sequence divided in groups of frames decomposed by means of a three-dimensional (3D) wavelet transform leading to a given number of successive resolution levels, said method being based on the hierarchical subband encoding process called “set partitioning in hierarchical trees” (SPIHT) and leading from the original set of picture elements (pixels) of the video sequence to wavelet transform coefficients encoded with a binary format, said coefficients being organized in trees and ordered in partitioning subsets—corresponding to respective levels of significance—by means of magnitude tests involving the pixels represented by three ordered lists called list of insignificant sets (LIS), list of insignificant pixels (LIP) and list of significant pixels (LSP), said tests being carried out in order to divide said original set of pixels into said partitioning subsets according to a division process that continues until each significant coefficient is encoded within said binary representation, and sign bits being also put in the output bitstream to be transmitted, said method being further characterized in that, for the estimation of the probabilities of occurrence of the symbols 0 and 1 in said lists at each level of significance, four models, represented by four context-trees, are considered, these models corresponding to the LIS, LIP, LSP and sign, and a further distinction is made between the models for the coefficient of luminance and those for the chrominance, without differentiating the U and V coefficients.

2. An encoding method according to claim 1, in which, for the encoding of each bit, a context formed of d bits preceding the current bit and different according to the model considered for said current bit is used, said contexts being distinguished for the luminance coefficients, the chrominance ones—while differentiating the U and V planes—and for every frame in the spatio-temporal decomposition, these contexts being gathered in a structure depending on the type of symbols, coming from the LIS, LIP, LSP or from the sign bitmap, on the color plane Y, U, or V, and on the frame in the temporal sub-band.

3. An encoding method according to claim 2, in which a representation of said contexts is a three-dimensional structure CONTEXT filled with the sequences of d last bits examined in each case:
CONTEXT [TYPE] [chroma] [n° frame] where TYPE is LIP_TYPE, LIS_TYPE, LSP_TYPE, or SIGN_TYPE, and chroma stands for Y, U, or V.
